(19) United States
(12) Patent Application Publication
(10) Pub. No.: US 2007/0233667 A1
(43) Pub. Date: Oct. 4, 2007

(54) Method and apparatus for sample categorization

(75) Inventor: Seshadri Mani, Surrey (CA)

Correspondence Address: BLAKELY SOKOLOFF TAYLOR & ZAFMAN, 1279 OAKMEAD PARKWAY, SUNNYVALE, CA, 94085-4040, US

(73) Assignee: BioPassword, LLC

(21) Appl. No.: 11/396,786

(22) Filed: Apr. 1, 2006

(51) Int. Cl. G06F 17/30

(52) U.S. Cl. 707/5

(57) ABSTRACT

A method and system for categorizing biometric measurements of a user is described. The method collects a plurality of biometric measurements of a user and validates the plurality of biometric measurements. The plurality of biometric measurements is categorized based on a plurality of predetermined parameters. A category with the most significant data set is identified. A status of the categorization process is returned to determine whether new samples are needed, whether the categorization process has successfully completed, or whether the categorization has completely failed. Other embodiments are described in the claims.

### FIELD

The embodiments of the invention relate to sample categorization for authenticating users of a computing system.

### BACKGROUND

Secured access to computer systems or user accounts ensures that only the authorized users may access the sensitive information contained within the computer systems and the user accounts. Conventionally, authorization to the computer systems and the user accounts relies mainly on variations of secret passwords. For example, a secret password consists of a combination of letters and/or numbers. Another method of authorization may require the user to answer a combination of questions about secured information which is usually known only to the user themselves, such as their birthday or their social security number.

A disadvantage for secret passwords or supplying secured information is that the security of these two methods may still be breached by unauthorized users tampering. Users often choose passwords that are easy to remember, such as a combination of numbers, a name, or a meaningful word. However, a combination of numbers, a name or a meaningful word can be easily determined via exhaustive search. Secured information such as a social security number, a birthday, mother's maiden name may also easily be stolen. It can easily be found in commercial databases such as the ones maintained by the credit bureau or the credit card companies.

Various approaches have been tried to improve the security of the computer systems. For example, in addition to entering the passcode for a bankcard, the account owner is required to swipe the bankcard through an automatic teller machine (ATM) so additional information such as the name on the account may be verified. However, unauthorized access may still happen when an unauthorized user gains possession of the bankcard and guesses the passcode.

Other authentication methods that do not rely on passwords or secured information have been proposed and implemented. These methods may rely on physical characteristics of a user, such as fingerprints, voice patterns and retinal images. However, these methods require special hardware such as the fingerprints, voice, or retinal recognition device.

Another authentication method may authorize users based on user input patterns. An example of an input pattern is the speed in which the user inputs the passwords. This method does not require complicated physical characteristic recognition systems and provides a cost effective and strong secure authentication method. It does not rely entirely on the content of the password or entirely on secured information.

Authentication methods that operate based on user characteristics collect user input samples. A measurement of such physical/behavioral characteristics may be referred to as biometric measurements. For example, when a user enters a password, the duration between keystrokes as the user types the password can be constructed as a biometric measurement. Another example is handwriting sampling wherein the size, the speed, or the duration between letters may be measured and constructed as a biometric measurement. Yet another example will be the measurement of the user's height, weight, hair color, blood samples, etc. For the purpose of this application, the terms “biometric measurements” and “raw samples” (e.g. raw data sample, input data, etc.) will be used interchangeably.

Because biometric measurements rely on a user's physical/behavioral characteristics rather than the secrecy of a passcode, the passcode is no longer required to remain secretive. When a user is authenticated via a biometric security system, the user's physical/behavioral characteristics are measured and compared with a predetermined template. If there is a match, the user is granted access. In the process of determining a template, the user may be required to enter multiple samples. An engine processes these multiple samples into a biometric template.

Variations may occur when a user enters multiple keystroke samples. For example, the timings of keystrokes from the first attempt may differ with the second attempt. It is possible that some of the samples may fall out of normal consistent keystroke times and hence would fall outside of normal distribution. Therefore, it is important to categorize these variations of samples and eliminate outliers. In eliminating outliers, a category of samples that best represents the physical/behavioral characteristics of the user may be found.

The category that best represents the physical/behavioral characteristics may be used to create a ‘tighter’ biometric template for future authentication purpose. What is needed is an efficient method to categorize the raw samples so the accuracy when authenticating a user based on the template may be improved.

### SUMMARY

The embodiments of the present invention disclose a method that collects a plurality of biometric measurements of a user and validates the plurality of biometric measurements. The plurality of biometric measurements is categorized based on a plurality of predetermined parameters. A category with the most significant data set is identified. A status of the categorization process is returned to determine whether new samples are needed, whether the categorization process has successfully completed, or whether the categorization has reached its threshold condition (Failure To Enroll condition).

### BRIEF DESCRIPTION OF DRAWINGS

Embodiments are illustrated by way of example and not by way of limitation in the figures of the accompanying drawings in which like references indicate similar elements. It should be noted that reference to “an” or “one” embodiment in this disclosure are not necessarily to the same embodiment, and such references mean “at least one.”

FIG. 1a shows a computer system including an input device according to an embodiment of the invention.

FIG. 1b depicts one method in which a biometric measurement may be collected according to an embodiment of the invention.

FIG. 2 is a flow chart illustrating the categorization process according to an embodiment of the invention.

FIG. 3 illustrates validating of input data according to an embodiment of the invention.

FIG. 4 depicts a flow chart illustrating the categorization of sample data according to an embodiment of the invention.

FIG. 5 depicts a block diagram illustrating the categorization of sample data according to an embodiment of the invention.

FIG. 6a depicts a flow chart illustrating the categorization of sample data until all samples have been categorized according to an embodiment of the invention.

FIG. 6b depicts a flow chart illustrating determining whether additional samples are needed according an embodiment of the invention.

FIG. 6c depicts a flow chart illustrating the details of categorization process according an embodiment of the invention.

FIG. 7 depicts a predictive identifier process according to an embodiment of the invention.

FIG. 8 depicts return success results according to an embodiment of the invention.

### DETAILED DESCRIPTION

Embodiments of categorizing samples of physical and/or behavioral characteristics associated with a prospective user of a computer system or user account are described. A person of ordinary skill in the pertinent art, upon reading the present disclosure, will recognize that various novel aspects and features of the present invention can be implemented independently or in any suitable combination, and further, that the disclosed embodiments are merely illustrative and not meant to be limiting.

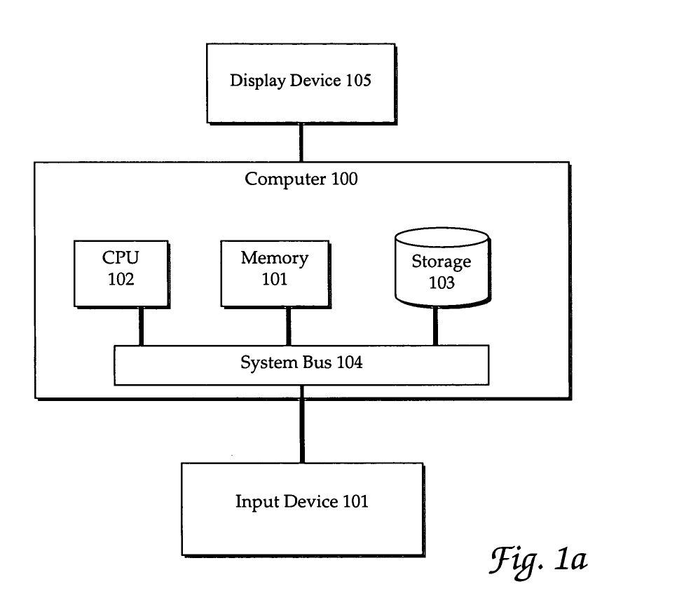

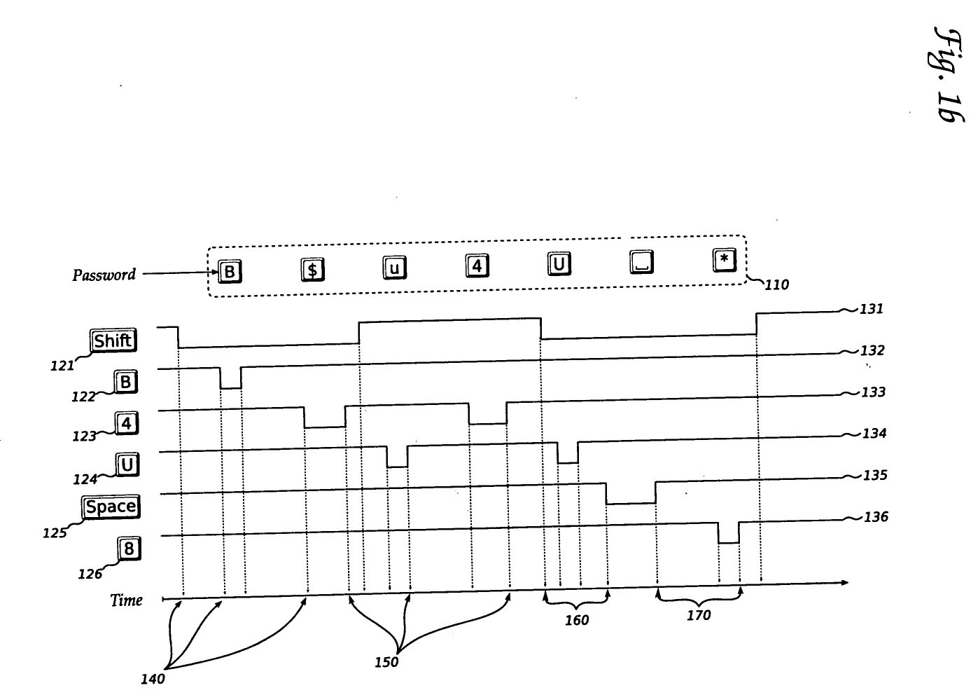

FIG. 1a shows computer system including an input device according to an embodiment of the invention. The system includes a computer unit 100, an input device 101, and display device 105. The computer unit 100 may be a general-purpose computer, including elements commonly found in such device: central processing unit (CPU) 102, memory 101, and storage device 103. Although not shown in the figure and not limited to the following examples, memory 101 device may include Read-Only Memory (ROMs), Random Access Memory (RAM), and cache.

The input device 101 may include any device that is capable of accepting input data from a user such as keyboard, mouse, pointing device, fingerprint reader, hand geometry measurement, microphone, and camera. Although not shown in the figure, the input device 101 may communicate with the computer unit 100 via an input/output (I/O) facility such as an I/O controller. In an embodiment of the invention, the input device 101 may be coupled to a network (not shown in FIG. 1) wherein the user is not required to be physically present near the computer unit 100. In this example, the user may input data from a remote location and the input data is collected and processed by the computer unit 100.

Within the computer unit 100, components such as the CPU 102, the memory 101, and the storage 103 may communicate with each other via a system bus 104. Alternatively, a special-purpose machine can be constructed with hardware, firmware and software modules to perform the operations described below.

FIG. 1b represents one way of collecting biometric data of a user. The user is typing the password “B$u4U *” 110. The timeline shows the six keys 121-126 involved in typing the password, and to the right of the keys, six corresponding traces 131-136 indicating when the keys are pressed and released. The data collected may include key press times 140, key release times 150, times from a first key press to a subsequent key press 160, and times between key releases 170. Some embodiments may collect (or compute) key press durations, overlaps (pressing one key before releasing the previous key), or other similar metrics. (Durations and overlaps not indicated in this Figure.) It is recognized in the art that these typing rhythm metrics vary from repetition to repetition and between typists.

Collecting keystroke-timing data as described above yields a vector of scalar quantities. Vectors are used first in an enrollment process to prepare a biometric template, and then later in a verification process according to an embodiment of the invention.

To authenticate a user based on the physical/behavioral characteristics, these characteristics are entered upon a request for authentication. The characteristics are then compared with a template. If the template matches the characteristics entered by the user within a predetermined threshold, the user is deemed authenticated. In order for authentication to be reliable, the template needs to be of good quality; in order to create a quality template, raw samples need to be categorized before and for template creation.

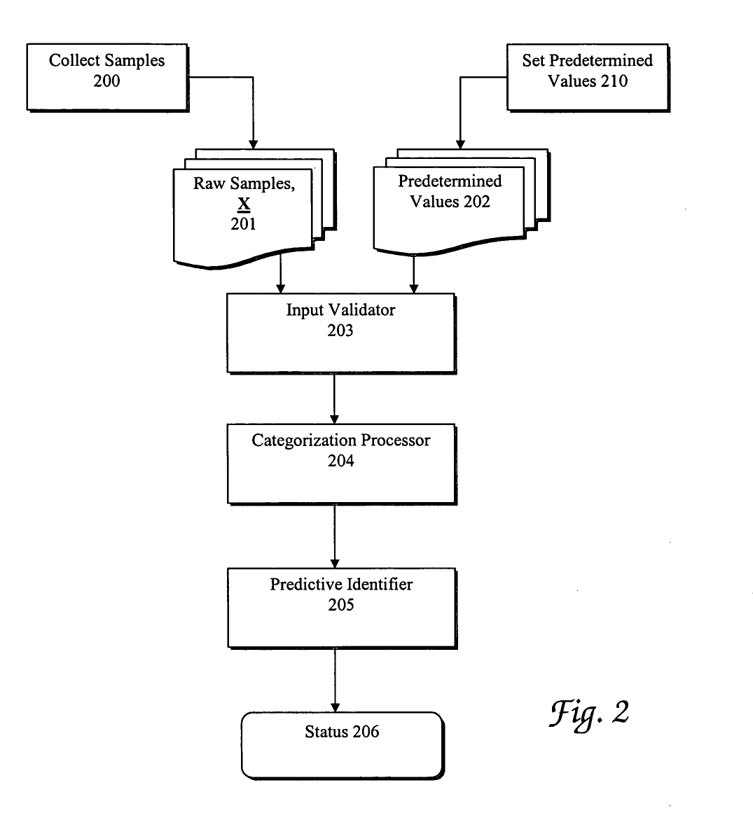

FIG. 2 depicts a flow chart illustrating the categorization process according to an embodiment of the invention. User samples such as the timing between each keystroke may be collected at 200. Each sample taken is considered a raw sample. Multiple raw samples 201 are needed for the categorization process.

Predetermined values 202 may be set by a system administrator at 210. For example, the system administrator may decide a categorization level (CE-level), a minimum number of categorized samples required for success N_{req}, (also referred as good samples), a maximum number of samples allowed, Nₘₐₓ, and a flag indicating whether to stop the update process once minimum number of categorized samples are captured. After the predetermined values 202 are set, the raw samples 201 and the predetermined values 202 may be validated by the input validator 203.

If the raw samples 201 are successfully validated by the input validator 203 then the raw samples 201 may be categorized by the subsequent categorization processor 204. Subsequent to sample categorization, a predictive indicator 205 may be used to identify the most significant category. The most significant category may then be used in a biometric template creation process.

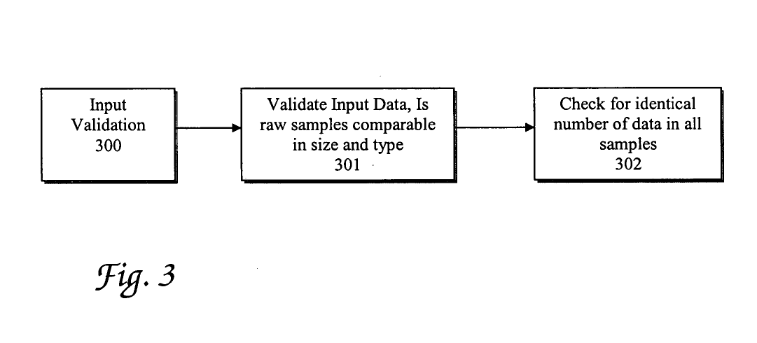

FIG. 3 illustrates validation of input data according to an embodiment of the invention. Input raw sample 201 is received by an input validator 203 as shown in FIG. 2. An input validation 300 accepts the input raw sample 201 and determined whether the number of raw samples 201 is comparable in size and type (301). For example, the number of raw samples 201 is compared with the minimum number of good samples required. If the number of raw samples 201 does not meet the minimum number of good sample required, additional samples will be required. Another method of validation may rely on not only the quantity of the raw samples entered, but on whether the raw samples entered at least match with the majority of the raw samples lexically. If the type of the data does not match a predetermined value (not shown), the raw samples 201 may be rejected and new sets of raw samples 201 may be required from the user.

After the raw samples 201 have been determined to be valid, the input validation 300 checks for identical number of data in all samples (303). Each sample taken from a user may construe a plurality of data or data points. To compare between samples, the number and type of the plurality of data or the number of data points need to be identical.

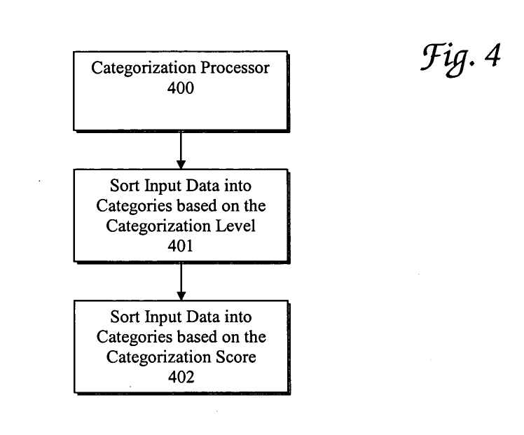

FIG. 4 depicts a flow chart illustrating the categorization of sample data according to an embodiment of the invention. Subsequent to the input validation process described in FIG. 3, the raw samples are ready for categorization by a categorization processor 400. The categorization processor 400 sorts the input raw sample into multiple categories based on the categorization level “CE-level” (401). The CE-level determines whether a raw sample should be grouped or categorized in a particular category. In an embodiment of the invention, the number of categories may be a predetermined value to be set by a system administrator as described in FIG. 2. In another embodiment of the invention, the number of categories may be determined dynamically while the raw samples are being categorized based on the CE-level.

The CE-level determines whether a sample should be included in a particular category. If the comparison of a sample with a category results in a value that lies within the CE-level, the sample is included in that category. The system administrator may set the CE-level according to different criteria such as the security level necessary. In an embodiment of the invention, a CE-level may be represented by a range of numbers (e.g. 0-100).

CE-level may be used in several ways. In an embodiment of the invention, the CE-level determines how “close” the raw samples have to be in order to be grouped or categorized in the same category. For example, in raw samples of 1, 2, 3, 6, 7, and 8, two categories of [1, 2, and 3 ] and {6, 7, and 8} may be categorized if the CE-level is set to 1 wherein 1 represents the raw samples must be equal or less than 1 from other raw samples to be categorized in the same category.

If there is more than one category where a particular raw sample may be grouped or categorized, a categorization score (CS) may be used to determine which category this particular raw sample would be grouped or categorized into (502). In an embodiment of the invention, the raw sample may be categorized in a category that has the higher value of CS.

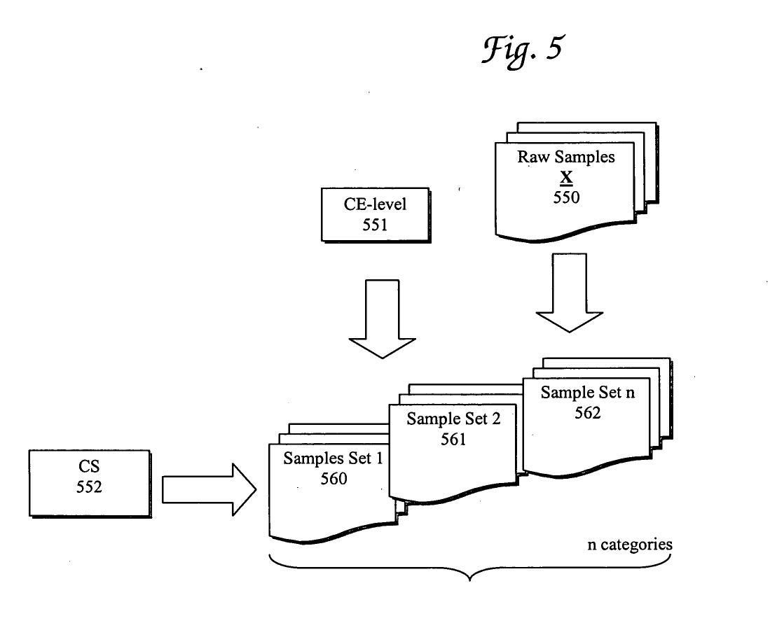

FIG. 5 depicts a block diagram illustrating the categorization of sample data according to an embodiment of the invention. This illustration is a visual presentation of FIG. 4. Raw samples 550, CE-level 551, and CS 552 are used to categorize the set of all raw samples 201 into n categories (e.g. sample set 1 560, sample set 1 561, . . . sample set n 562.

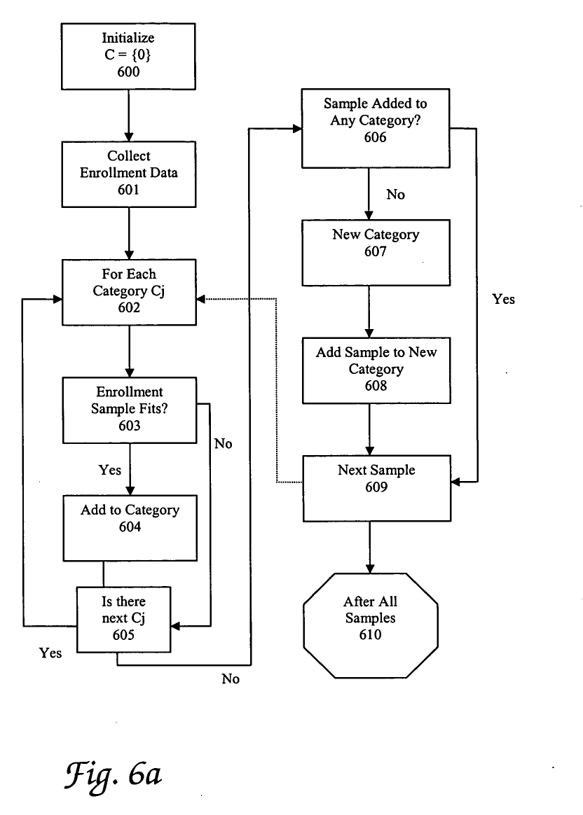

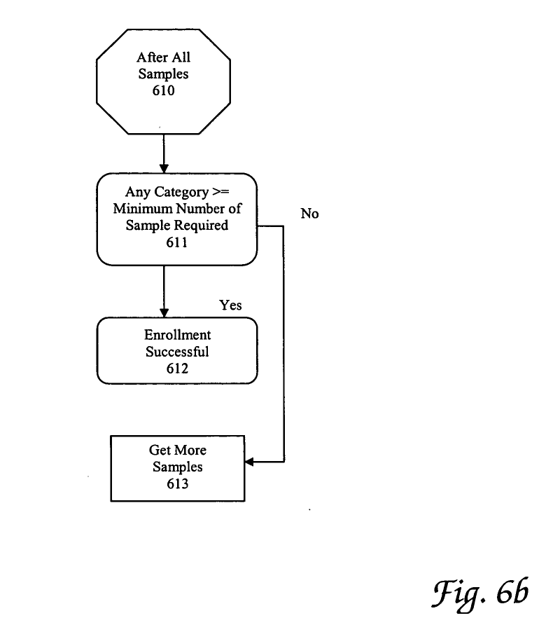

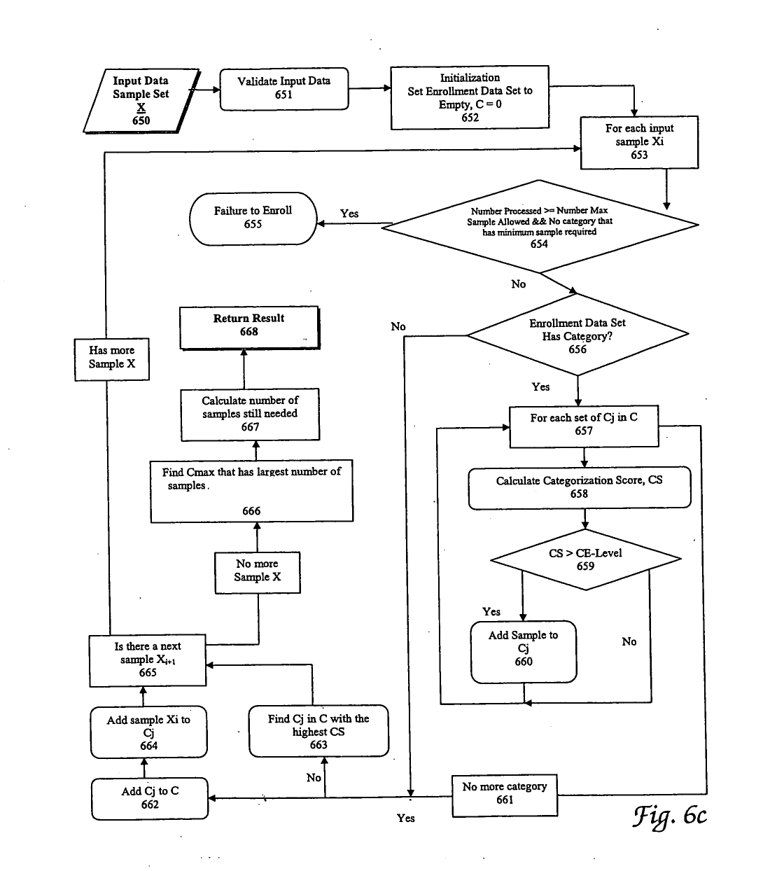

FIG. 6a depicts a flow chart illustrating the categorization of sample data until all samples have been categorized according to an embodiment of the invention. In 600, a set of categories, C, is initialized by setting C=0 (the empty set). Subsequently, enrollment data is collected at 601. For each category Cj ε C (602) (initially for no Cj, since C is empty to begin with), a determination is made to check whether the enrollment sample or data fits (operation 603). If the enrollment sample fits, the enrollment sample is added to Cj in 604. If the enrollment sample does not fit, a check is made at 605 to see whether there is another category. If there is another category, the next category is used to determine whether the enrollment sample fits in that category at 602.

After all the categories have been verified, check to see whether the enrollment data has been added to any one of the categories at 606. If the enrollment sample has not been added to any category and there are no more categories, a new category is added to the set C of all categories at 607. Subsequently, the enrollment sample is added to this new category at 608.

If the enrollment sample has been added to at least one category at 606, the categorization process categorizes the next enrollment sample at 609. At this point, operation 602 accepts the next enrollment sample. This process may be iterated until all the samples have been categorized at 610.

FIG. 6b depicts a flow chart illustrating determining whether additional samples are needed according to an embodiment of the invention. After all the enrollment samples have been categorized as described in FIG. 6a, a category is selected if the number of samples in that category is greater than or equal to the minimum number of samples required at 611. If a category is found to have satisfied this condition, the categorization process returns with an enrollment successful status at 612. If no category satisfies this condition, a user is prompted for more enrollment samples (operation 613).

FIG. 6c depicts a flow chart illustrating the details of a categorization process according to an embodiment of the invention. Input data is collected at 650. The collected data may be organized into a set, X. Input data may include raw samples collected from a user. An example of the raw samples is biometric keystroke samples of a user in a behavioral biometric solution.

Input data may also include predetermined values set by a system administrator. The input data 650 is validated at operation 651. After the input data 650 is validated, an enrollment data set, C, is initialized at operation 652. This may be accomplished by setting C=Ø (the empty set). At this point, no raw samples have been categorized.

Subsequently, each enrollment sample in raw samples, X, may be evaluated at operation 653. If the number of raw samples processed is equal to or greater than the maximum number of raw samples allowed and if no category contains a minimum number of samples required (654), then a failure to enroll (FTE) status is returned (655). If the number of raw samples processed or categorized is less than the maximum number of raw samples or there is no category containing a minimum number of samples required, the operations proceed to operation 656.

Each element within the set of categories C is set of raw samples. For example, C={C₁, C₂, C₃, . . . , Cₙ} wherein C includes n elements and each Cᵢ, for i=1 . . . n, Cᵢ={X₁, . . . Xₘ₍ᵢ₎}, where Xj ε X. In operation 656, the category set is checked to see if the set contains at least a category. Each set Cj in the category set is evaluated (operation 657). In operation 658, for each set Cⱼ, a categorization score CS is determined for a given enrollment sample. If the CS for that particular category is greater than a predetermined CE-Level, then the enrollment sample is added to that category. After the sample has been added to the category in operation 660, the next category is evaluated at 657.

If the CS is less than or equal to the CE-level (operation 659), the enrollment sample is not added to the category Cj. Then the next category is evaluated at 657. If there are no more categories and the enrollment sample has not yet been added to a category (operation 661), a new category is created at 662. In an embodiment of the invention, if an enrollment sample's CS scores are such that the sample may be added to multiple categories, the enrollment sample is added to the category with the highest CS in operation 663. In another embodiment of the invention, if an enrollment sample's CS scores are such that the sample may be added to multiple categories, the enrollment sample is added to all those categories.

An example of calculating CS is to determine the distance measure between the sample and the average of samples that are already part of category Cᵢ. The smaller the distance measure the higher is the resulting categorization score. Scoring systems that support comparison of homogenous data sets can be used to determine the categorization score.

When a new category is added in 662, the enrollment sample Xi is added to that category in 664. After the enrollment sample has been added to at least one category, a next enrollment sample is evaluated at 665. At this point, the process repeats again starting from operation 653. If there are no more samples, the category with the largest number of samples is determined at operation 666. This number may be set to a variable named, N_{cat}. In an embodiment of the invention, if a categorized set has reached the minimum number of samples needed, then that category is selected and processing of the system finishes. For example, if the minimum number of categorized keystroke samples is 10 and there are 50 raw samples fed into the categorization system, processing will stop as soon as any category contains the minimum number of 10 samples. In another embodiment of the invention, processing will continue until all samples have been evaluated; the category with the largest number of samples is then selected as the category to be used to produce the template.

If the category with the largest number of samples also meets the minimum number of samples requirement, the category may be determined to be a successful category and a result of successful categorization may be returned at 668.

Operation 667 calculates the number of samples needed in operation, 667. When the largest number of samples, N_{cat}, in the categories set has been determined, the number of samples that is still required (e.g. N_{needed}) may be determined. This may be the case when the largest number of samples, N_{cat}, is less than the minimum number of samples required (e.g. N_{req}) to finish the categorization process. N_{req} may be a predetermined value as discussed above. The number of samples still required may be calculated by the difference between the number required and the number of the largest number of samples in the categorized set. For example, N_{needed}=N_{req}-N_{cat}. At this point, a user may be prompted to enter more samples. A signal or notification may be sent as a return result to the user at operation 668.

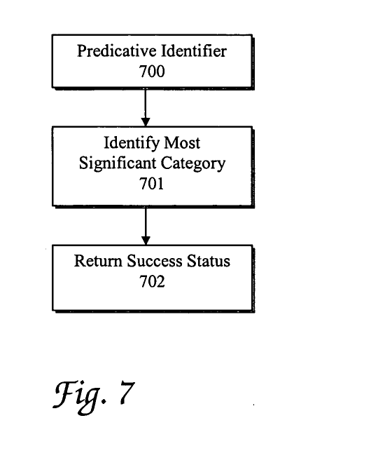

FIG. 7 depicts a predictive identifier process according to an embodiment of the invention. A predictive identifier 700 determines one category subsequent to the categorization process described above. The most significant category is selected by the predictive identifier 701. Different factors may be used to determine the category to be selected depending on the nature of the raw samples. For example, if the raw samples are the biometric keystroke timing measurements as discussed above, a category may be selected if it has the maximum number of raw samples compared to other categories. The predictive identifier 700 may return success status 702 after the selection of the category. If not successful, it returns the number of samples needed or fail to enroll condition as stated below.

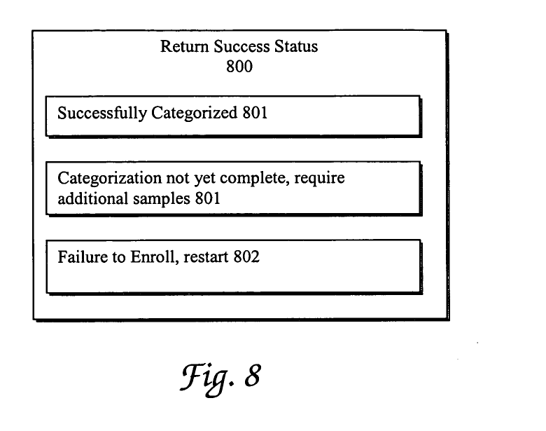

FIG. 8 depicts return success status results according to an embodiment of the invention. Return success status 800 may be used to identify whether the categorization process has been successful. In 801, the status may indicate that the raw samples have been successfully categorized. In 802, the status may indicate that the categorization has not yet completed because additional raw samples are required. In addition to returning the status 802, a minimum number of samples required may also be returned to a user wherein the user may be required to input additional raw samples. In 803, the status may indicate that the categorization process is not successful and Fail to enroll condition is reached. This condition occurs if the total number of samples processed exceeds the maximum allowable limit, Nₘₐₓ, and if no one category contains the minimum number of samples required, N_{req}, for successful processing. The user may be asked to restart the contribution of samples.

A machine-readable medium may include any mechanism for storing or transmitting information in a form readable by a machine (e.g. a computer), including but not limited to Compact Disc Read-Only Memory (CD-ROMs), Digital Versatile Disks (DVD), Universal Media Disc (UMD), High Definition Digital Versatile Disks (HD-DVD), hard drive, Read-Only Memory (ROMs), Random Access Memory (RAM), Erasable Programmable Read-Only Memory (EPROM), and a transmission over the Internet, Wide Area Network (WAN), Local Area Network, Bluetooth Network, and/or Wireless Network.

The applications of the present invention have been described largely by reference to specific examples and in terms of particular allocations of functionality to certain hardware and/or software components. However, those of skill in the art will recognize that data comparisons according to the multi-distant weighted scoring system disclosed herein can also be produced by software and hardware that distribute the functions of embodiments of this invention differently than herein described. Such variations and implementations are understood to be captured according to the following claims.

Although the invention has been described in detail hereinabove, it should be appreciated that many variations and/or modifications and/or alternative embodiments of the basic inventive concepts taught herein that may appear to those skilled in the pertinent art will still fall within the spirit and scope of the present invention as defined in the appended claims.

We claim:

1. A method comprising:
collecting a plurality of biometric measurements of a user;
categorizing the plurality of biometric measurements based on a plurality of predetermined parameters;
identifying a category based on the categorization of the plurality of biometric measurements, wherein the category has a largest number of the biometric measurements; and
determining a status of the categorization.

2. The method of claim 1, wherein the predetermined parameters include a categorization level, a maximum number of samples allowed, a minimum number of categorized samples required, and a flag indicating whether to continue the update process or stop it once the minimum samples have been gathered.

3. The method of claim 1 further comprising of validating the plurality of biometric measurements of a user, wherein the plurality of biometric measurements includes a plurality of keystroke timing values.

4. The method of claim 2, wherein a biometric measurement is categorized within a category based on a categorization score.

5. The method of claim 4, wherein the biometric measurement is further categorized within the category based on the categorization level.

6. The method of claim 1, wherein a status includes successfully completed categorization, more biometric measurement required, and that a threshold condition has met.

7. The method of claim 6, wherein the threshold condition is failure to enroll.

8. A method comprising:
collecting a set of measurements;
validating the measurements based on the plurality of predetermined parameters;
categorizing the measurements based on a plurality of predetermined parameters, wherein the measurements is grouped in a data set;
identifying a category based on the grouping of the measurements; and
determining a status of the categorization.

9. The method of claim 8, wherein the predetermined parameters include a categorization level, a maximum number of samples allowed, a minimum number of categorized samples required, and a flag indicating whether to continue the update process or stop it once the minimum samples have been gathered.

10. The method of claim 8, wherein the measurement includes biometric measurement of a user.

11. The method of claim 10, wherein the categorization level determines whether a biometric measurement of the biometric measurements should be categorized in a plurality of categories

12. The method of claim 10 further includes sorting the biometric measurements into a plurality of categories based on the categorization level and a categorization score, wherein the categorization score is determined based on a biometric measurement and the data set.

13. The method of claim 10, wherein the identification of the category includes the data set that has the maximum number of biometric measurements.

14. A system comprising:
collector for collecting a plurality of biometric measurements of a user;
categorizer for categorizing the plurality of biometric measurements based on a plurality of predetermined parameters;
predictive identifier for identifying a category based on the categorization of the plurality of biometric measurements; and
status indicator indicating a status of the categorization.

15. The system of claim 14, wherein the predetermined parameters include a categorization level, a maximum number of samples allowed, and a minimum number of categorized samples required.

16. The system of claim 15, wherein a biometric measurement is categorized within a category base on the categorization level.

17. The system of claim 14 further includes sorting the plurality of biometric measurements into a plurality of categories based on the categorization level and a categorization score, wherein the categorization score is determined based on a biometric measurement and the enrollment data set.

18. The system of claim 17, wherein the identification of the category includes the largest number of the enrollment data set.

19. The system of claim 17, wherein the categorization data with the highest categorization score is placed in the categorization result set.

20. The system of claim 17, wherein a user is prompted to input additional plurality of biometric measurements if it is determined that the number of the largest biometric measurements in the identified category is less than the minimum number of categorized samples required.

21. A machine-accessible medium that provides instructions that, when executed by a processor, causes the processor to:
collect a plurality of biometric measurements of a user;
categorize the plurality of biometric measurements based on a plurality of predetermined parameters;
identify a category based on the categorization of the plurality of biometric measurements; and
determine a status of the categorization.

22. The machine-accessible medium of claim 21, wherein the predetermined parameters include a categorization level, a maximum number of samples allowed, and a minimum number of categorized samples required.

23. The machine-accessible medium of claim 22, wherein the categorization level determines whether a biometric measurement of the plurality of biometric measurements should be categorized in a plurality of categories.

24. The machine-accessible medium of claim 21 further includes sorting the plurality of biometric measurements into a plurality of categories based on the categorization level and a categorization score, wherein the categorization score is determined based on a biometric measurement and the enrollment data set.

25. The machine-accessible medium of claim 21, wherein the identification of the category includes the largest number of an enrollment data set.
